(19) United States
(12) Patent Application Publication
(10) Pub. No.: US 2005/0278247 A1
(43) Pub. Date: Dec. 15, 2005

(54) Method and system for creating a purchasing strategy for a commodity

(75) Inventors: Andy Benedict, Bloomfield Hills, MI (US); Edward John Blanch, Bloomfield Hills, MI (US); Elizabeth Ann Campbell, Northville, MI (US)

Correspondence Address: BROOKS KUSHMAN P.C./FGTL, 1000 TOWN CENTER, 22ND FLOOR, SOUTHFIELD, MI, 48075-1238, US

(73) Assignee: Ford Motor Company, Dearborn, MI (US)

(21) Appl. No.: 10/868,157

(22) Filed: Jun. 15, 2004

(51) Int. Cl. G06F 17/60

(52) U.S. Cl. 705/38

(57) ABSTRACT

Method and system for generating a report for use in buyer/supplier negotiations for purchasing a commodity. Embodiments include collecting data to define the technical capabilities of two or more suppliers to supply a commodity to a buyer, collecting data to define attributes of the commodity and the commodity market, and collecting data from the selected suppliers to identify their relative competitive position. Collected data is input into a computer configured to process at least a portion of the collected data and output a consolidated report for use in negotiations. Opportunities for improving supplier competitive position may be identified. During buyer/supplier negotiation, a supplier may be encouraged or required to (i) adopt one or more of the competitive opportunities identified in the strategy report or (ii) agree to adjusted contract terms in compensation for not adopting one or more of the competitive opportunities illustrated in the strategy report.

### BACKGROUND OF THE INVENTION

1. Field of the Invention

The present invention relates generally to methods of conducting business and, more particularly, to methods and systems for collecting, processing and effectively utilizing market information in supplier negotiations.

2. Background Art

Commodity buyers today do not have an efficient framework for evaluating the supply base in view of program requirements and identifying opportunities for improving the competitive position of their suppliers. As a result, buyer/supplier negotiation activities may be carried out on an “ad hoc” basis unsupported by comprehensive factual information.

The present invention exploits valuable market, commodity and supplier knowledge is readily accessible to buyers. When collected, organized and utilized properly, this information becomes “fact-based” leverage during buyer/supplier negotiations that may lead to cost reduction as well as an increase the in the dependability and quality of the purchased commodity.

### SUMMARY OF THE INVENTION

One objective of the present invention is to provide a buyer with a tool and methodology for improving the buyer's commodity cost position among suppliers. The present invention enables a buyer to efficiently collect and effectively utilize comprehensive supplier knowledge associated with a commodity. With such a tool, the buyer is well suited to effectively negotiate with its suppliers. Due to the accessibility of the comprehensive knowledge base that the present invention provides, a buyer can more effectively encourage its suppliers to adopt best-in-class processes and techniques resulting in increased quality and/or an even greater cost reduction. Ultimately, the present invention may enable a buyer to enter into long-term and cooperative relationships with its suppliers yielding better products at lower cost.

Central to the effectiveness of the present invention is the collection of key data that will assist a buyer in discovering and understanding cost saving opportunities. Table 1 below includes example questions, the answers to which may provide some of the necessary data for identifying cost saving opportunities among suppliers of a commodity.

TABLE 1

| | | | | | |
|---|---|---|---|---|---|
| General | Am I paying | Am I buying | What price | Am I able to | Am I buying |
| Question | the right | from the | reduction(s) | influence the | efficiently? |
| Categories | price? | right | should I be | product | |
| | | supplier(s)? | receiving? | specification? | |
| Detailed | Is our price | What are the | Is my | Can the | Is my |
| Questions | out of line | suppliers' | commodity | product | relationship |
| | with the | capabilities? | influenced by | specification | with the |
| | benchmarks? | | market | be changed to | supplier |
| | | | economics? | optimize the | focused on |
| | Does our | What | How quickly | purchase | reducing |
| | price | capabilities | are market/ | price? | costs? |
| | accurately | are available | industry | | |
| | reflect the | in the | prices | | |
| | supplier | industry? | declining? | | |
| | cost | | | | |
| | structure? | | | | |
| | Does our | Am I aligned | Are my prices | | |
| | price | with the | declining | | |
| | reflect | correct | consistently | | |
| | historical | suppliers? | with market | | |
| | trends in | | trends? | | |
| | industry | | | | |
| | prices? | | | | |

One embodiment of the present invention includes a method for generating a report for use in buyer/supplier negotiations for purchasing a commodity. One aspect of this embodiment may include the steps of collecting data to define the technical capabilities of two or more suppliers to supply a commodity to a buyer, collecting data to define attributes of the commodity and the commodity market, and collecting data from the selected suppliers to identify their relative competitive position. Another aspect of this preferred methodology includes inputting the collected data into a computer operably configured to process at least a portion of the collected data and output a report containing at least a portion of (i) the technical capabilities of the selected suppliers, (ii) the attributes of the commodity and commodity market, and (iii) the relative competitive position illustrating one or more competitive opportunities.

Embodiments of the present invention may also include identifying competitive opportunities based on the report. The competitive opportunities may include cost reduction, quality improvement or capability improvement, etc.

Additionally, the present invention may include the step of negotiating a supply agreement with at least one supplier based on information provided in the strategy report. During buyer/supplier negotiation, a supplier may be encouraged or required to (i) adopt one or more of the competitive opportunities identified in the strategy report, or (ii) agree to adjusted contract terms in compensation for not adopting one or more of the competitive opportunities illustrated in the strategy report. In some instances, at least a portion of the strategy report may be communicated to the supplier during negotiation.

Another embodiment of the present invention includes a system for generating a report for use in buyer/supplier negotiations for purchasing a commodity. The system may include one or more computers operably programmed to receive input data defining technical capabilities of two or more suppliers of a commodity, defining attributes of the commodity and the commodity market, and defining a relative competitive position of two or more of the suppliers. The computer(s) may additionally be configured to process the input data to generate a report including at least a portion of the input data and output the report. The report may then be used during buyer/supplier negotiations for purchasing a commodity. The computer(s) may additionally be configured to receive input selecting a subset of the input data to be included within the strategy report.

### BRIEF DESCRIPTION OF THE DRAWINGS

FIG. 1 is a block flow diagram illustrating a preferred methodology or “milestones” for implementing the present invention;

FIG. 2 is a GUI illustrating an example “Data View” screen in accordance with one embodiment of the present invention;

FIG. 3 illustrates an example input data catalog for the “Technology Strategy” data group in accordance with one embodiment of the present invention;

FIG. 4 is a GUI illustrating an example “Chart View” screen in accordance with one embodiment of the present invention;

FIG. 5 is an example “Patents Issued” chart that may be automatically generated and included within a consolidated report generated in accordance with the present invention;

FIG. 6 is an example “Framework for Commodity Strategy” chart that may be automatically generated and included within a consolidated report generated in accordance with the present invention; and

FIG. 7 is a schematic diagram graphically illustrating a system implementation of the present invention.

### DETAILED DESCRIPTION OF THE PREFERRED EMBODIMENT(S)

Embodiments of the present invention include a method and system for developing and implementing a buyer negotiation strategy for a commodity. For illustrative purposes only, some aspects or embodiments of the present invention are described in the context of the automotive purchasing arena. Notably, however, the present invention may be applied to a broad spectrum of technical and non-technical industries that implement or desire to implement competitive buying strategies.

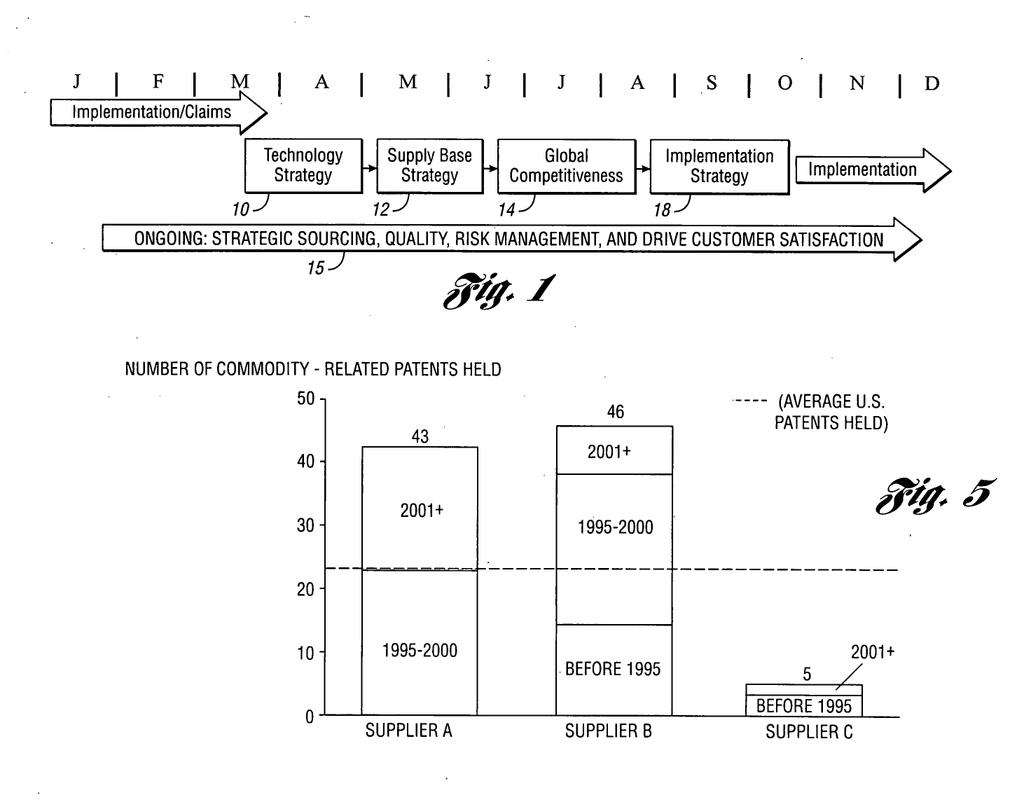

FIG. 1 is a block flow diagram illustrating a preferred methodology or “milestones” for implementing the present invention. Notably, the content or arrangement of the flow diagram illustrated in FIG. 1 can be truncated, rearranged or otherwise modified to best fit a particular implementation of the present invention. As reflected in block 10, a “Technology Strategy” step of the preferred methodology includes assessing supplier capabilities to meet a buyer's current or future requirements for a commodity. This aspect of the present invention may include collecting data to define the technical capabilities of various suppliers positioned to supply the commodity to the buyer. This step of the methodology seeks to illustrate the alignment (or misalignment) between a buyer's program requirements for a commodity and the capabilities of suppliers for that commodity. Notably, old suppliers, current suppliers, potential suppliers and competitors' suppliers, as well as potential suppliers outside of the buyer's industry, should be considered in this analysis.

As reflected in block 12, a “Supply Base Strategy” step of the preferred methodology includes selecting one or more suppliers for the commodity based on the assessment of supplier capabilities referred to in block 10. Data defining attributes of the commodity and the commodity market may be collected during this aspect of the present invention. In this manner, the supplier(s) that is/are best aligned with the buyer's program requirements are selected to supply or potentially supply the commodity.

As reflected in block 14, a “Global Competitiveness” step of the preferred methodology may include benchmarking the competitive position of suppliers for the commodity. This aspect of the present invention may assist in identifying one or more opportunities for improving supplier competitive position (e.g., decrease the cost of the commodity, increase the dependability of the commodity, increase the quality of the commodity, etc.).

In other words, the capabilities of the entire supplier base for the commodity are benchmarked. From this benchmark, gaps are typically identified between the capabilities of the selected supplier and the buyer's program requirements, as well as gaps among the suppliers' own capabilities with respect to one another. Although a selected supplier may be best aligned with the buyer's needs, that supplier may not be implementing the best processes, etc., available to improve product quality/value and/or reduce cost to the buyer. Improving supplier capabilities may include improving product quality, increasing manufacturing efficiency, reducing manufacturing cost, improving timing, improving value, etc.

Yet another step of the preferred methodology, as represented in block 16, includes creating an “Implementation Strategy” for at least one of the selected suppliers based on the assessment represented in block 10 and the benchmark represented in block 14.

Additional steps may include implementing the negotiation strategy 18, i.e., negotiating a supply agreement with one or more of the selected suppliers. During this step, a negotiating supplier may be encouraged to reduce cost for the commodity based on the assessment and benchmark data provided by the negotiation strategy. To do so, the supplier may be encouraged to adopt the best-in-class processes, etc., identified in the benchmark.

Preferably, these and other aspects of the present invention are implemented in an annual fashion. Ongoing activities 15 may include strategic sourcing, quality analyses, risk management, and customer satisfaction activities. Notably, however, aspects of the present invention may be practiced, and results may be realized, without reference to the preferred annual schedule for implementing the present invention. These and other aspects of the present invention are illustrated and described in greater detail below.

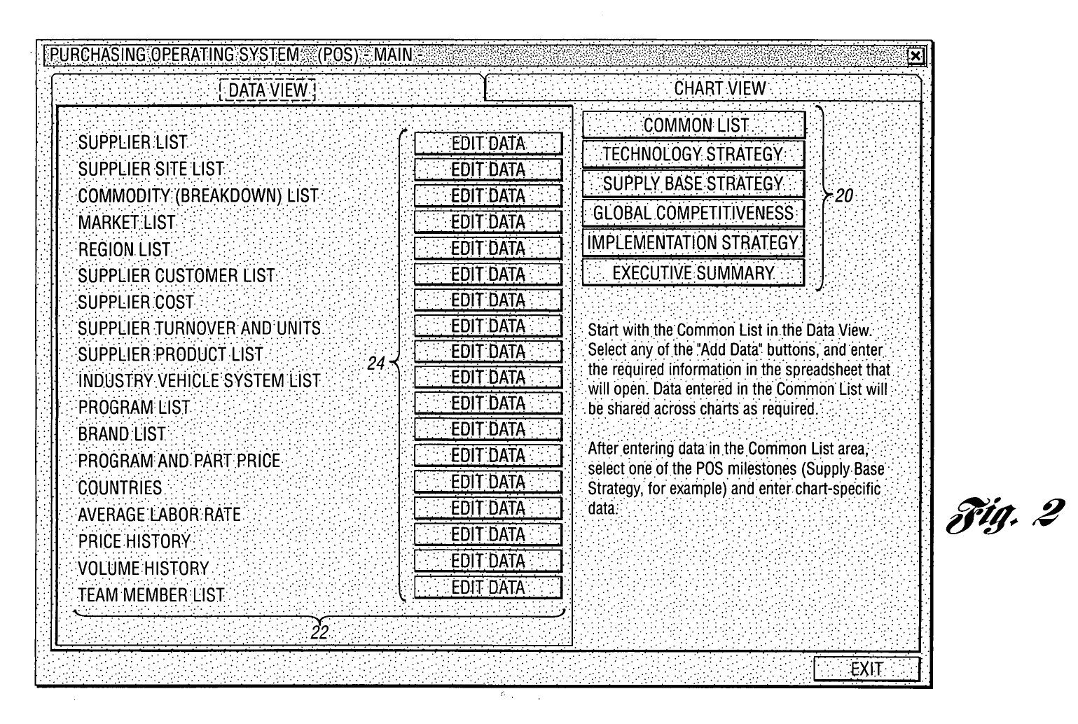

FIGS. 2 through 4 illustrate example graphical user interfaces (GUIs) for implementing the present invention. Computer functionality in addition to that illustrated in FIGS. 2 through 4 are discussed also. Those of ordinary skill in the field of software development and commodity purchasing are well versed in reducing these described interfaces to practice within the scope of the present invention.

FIG. 2 is a GUI illustrating an example “Data View” screen in accordance with one embodiment of the present invention. The Data View screen includes a group of buttons 20 for toggling among different input data groups utilized for implementing the present invention (Common List, Technology Strategy, Supply Base Strategy, etc.). Depending on the button selected, a selectable input data catalog 22 is provided. FIG. 2 illustrates the input data catalog for the “Common List” data group. The “Common List” data group includes the categories of data that are shared between one or more of the other data groups. This feature of the present invention enables a user to enter shared data once—thereby increasing data input speed and reducing the possibility of errors associated with redundant data entry.

By selecting any of the add/edit buttons 24, the user is presented with a corresponding data entry interface (not shown). In one embodiment, the data entry interface is provided in a spreadsheet format. The “Supplier List” data category defines suppliers for the commodity. The “Supplier Site List data category defines the site locations for each supplier. Some suppliers may have more than one site location. The “Commodity Breakdown List” data category defines the different segments of the commodity, if any. For example, a “brake” commodity may be segmented into rotors, calipers, pads and drums. This information may be used to construct an overall map of the annual buy by component and supplier.

The “Market List” data category defines the different markets in which the commodity may be purchased. This information may be used to construct a chart illustrating the amount that each supplier sells to these markets. In the automotive industry, markets might include “OEM” and “Aftermarket”. The “Region List” data category defines the different regions in which the commodity is used. These regions may be broad or narrow. This information may be used to compare the different regions that use the commodity in terms of size, growth, etc. The “Supplier Customer List” data category defines the different customers that are known to use the commodity. This information may be used to construct a chart illustrating the amount of the commodity that each supplier provides to each customer.

The “Supplier Cost” data category defines a breakdown, for each supplier, of the relative percentage of product cost among various cost categories (e.g., raw material, purchased parts, packaging, direct labor, indirect labor, MRO labor, manufacturing overhead, corporate overhead, research & development, profit, etc.).

The “Supplier Turnover and Units” data category defines a summary, for each supplier, of the annual turnover, units sold, and a resulting average price per unit. This information may be used to construct a chart mapping annual buy and units. The “Supplier Product List data category defines a listing of all products, including the commodity of interest, that the supply base produces. This information may be used to create a chart illustrating what percent of the commodity is reflected in the total sales for each supplier, and what other products they produce. The “Industry Vehicle System List” data category defines a listing of overall product (e.g., vehicle) systems in which the commodity is used.

The “Program List” data category defines a listing of all programs (i.e., products) the buyer/manufacturer produces. This information may be used to create a part price comparison chart. The “Brand List” data category defines all brand names under which the buyer/manufacturer markets its products. This information may be used to create a chart illustrating the level of turnover for each supplier in each brand. The “Program and Part Price” data category defines a summary, for each product/program, of the associated retail product price and the part price for the commodity for each product/program. This information may be used to create a chart to compare vehicle selling price and part price. The “Countries” data category defines a listing of all countries in which the suppliers have a manufacturing presence. This information may be used to create a chart to compare average supplier labor rates by country.

The “Average Labor Rate” data category defines a listing of the average labor rate in each country in which the suppliers have a presence. This information may be used to create a chart to compare average supplier labor rates by country. The “Price History” data category defines a listing, by year, of unit prices for the commodity, or “unit of experience” for the commodity. Preferably, this listing is accompanied by a listing of the average industry unit prices for the corresponding years. This information may be used to create a price history chart and/or an experience curve for the commodity. The “Volume History” data category defines a listing, by year, of buyer purchasing volumes for the commodity. Preferably, this listing is accompanied by a listing of the average industry volumes for the corresponding years. This information may be used to create a volume history chart and/or an experience curve for the commodity. The “Team Member List” data category defines one or more team members involved in creating the purchasing strategy for the commodity.

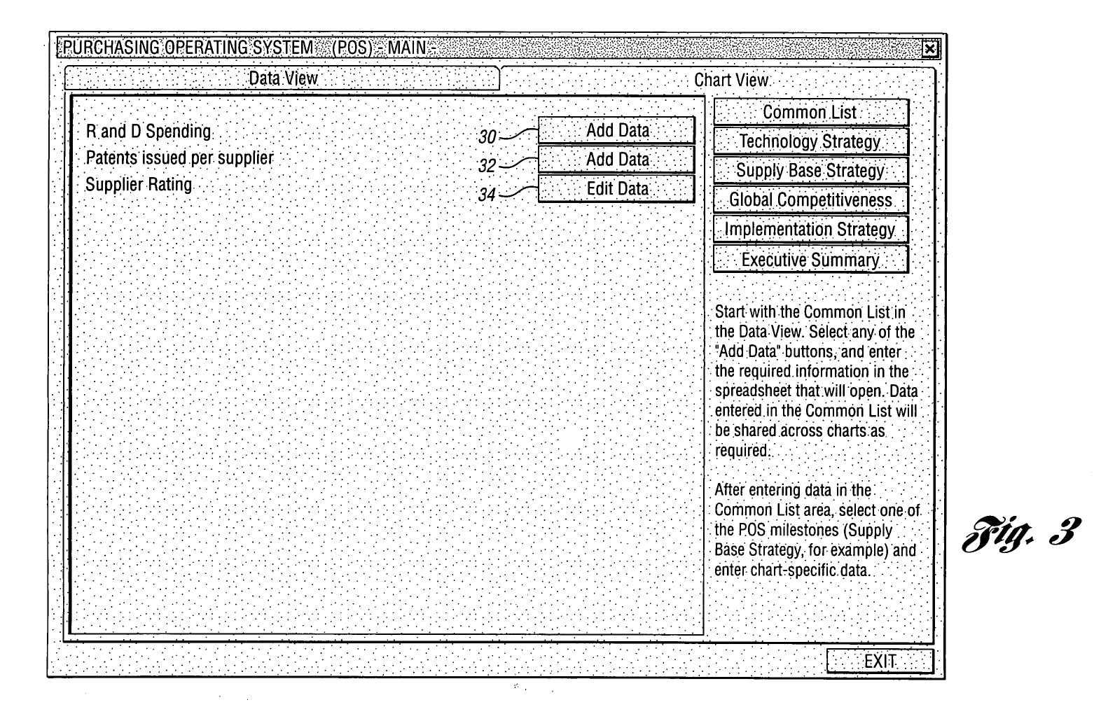

FIG. 3 illustrates an example input data catalog for the “Technology Strategy” data group in accordance with one embodiment of the present invention. The “R and D Spending” data category 30 may be utilized to define the percent investment each supplier makes annually in research and development. The “Patents Issued per Supplier” data category 32 may be utilized to define the number of patents that issued or were assigned to each supplier annually. The “Supplier Rating” data category 34 may be utilized to define a summary, for each supplier of its rank (e.g., 1-3) for a variety of different subjective categories (e.g., relationship with buyer, annual turnover, long-term supplier, strategic alignment, performance, quality, technology, cost, delivery, financial status, capacity utilization, total industry market share, etc., and a total for each category).

The data catalog for the “Supply Base Strategy” data group is not shown, but is similar in appearance to the graphical user interface illustrated in FIG. 3. The supply base strategy data catalog may include a “Commodity Analysis” category and a “Supplier Industry Analysis” category. The “Commodity Analysis” category may include supplier turnover and units (discussed above), turnover by supplier and commodity, turnover by supplier by year, turnover by commodity by year, and a supplier product mix. The supplier product mix defines, for each supplier, the total amount of sales revenue for each product that the supplier manufactures/sells. The “Supplier Industry Analysis” category may include the supplier rating (discussed above), turnover by region by year, units by region by year, total market overview (defining the amount that each supplier sells to the different markets the commodity is available in), industry vehicle system overview (defining turnover for each product/vehicle by year), turnover by supplier by market, turnover by supplier by customer, PPM rate for each supplier site, growth rate of commodity turnover by supplier, commodity spend by vehicle/product program, and global spend by supplier by brand/region.

The data catalog for the “Global Competitiveness” data group (not shown) may include a “Cost Competitive Analysis” category and a “Financial Metrics and Experience Curve Analysis” category. The “Cost Competitive Analysis” category may include a part price comparison, a summary of average part prices by supplier, a supplier cost element comparison, a summary of supplier average prices and volumes, and labor rate data. In the labor rate data category, the user inputs, for each supplier and corresponding country of presence, the percentage of manufacturing the suppliers host in each country. The “Financial Metrics and Experience Curve Analysis” category may include a “liquidity ratio” for each supplier, the financial efficiency for each supplier (e.g., inventory days, payable days, receivable days, sales/assets, etc.), supplier leverage (e.g., debt/equity, debt/asset, interest coverage, etc.), supplier profitability (e.g., gross margin, operating margin, return on sales, etc.), relative market share for each supplier, industry experience data (e.g., price and cumulative volume by year), and a buyer experience curve. In accordance with a preferred embodiment of the present invention, a “liquidity ratio” may be thought of as a combination of a current ratio (e.g., current assets divided by current liabilities) and a quick ratio (e.g., cash and cash equivalent assets divided by current liabilities).

The data catalog for the “Implementation Strategy” data group (not shown) may receive input scheduling purchasing activity related to the commodity (e.g., over a calendar year), a key supplier competitive gap analysis matrix, a performance forecast for negotiation, a progress plan, a cross-brand/cross-commodity turnover analysis, and a cost-down roadmap.

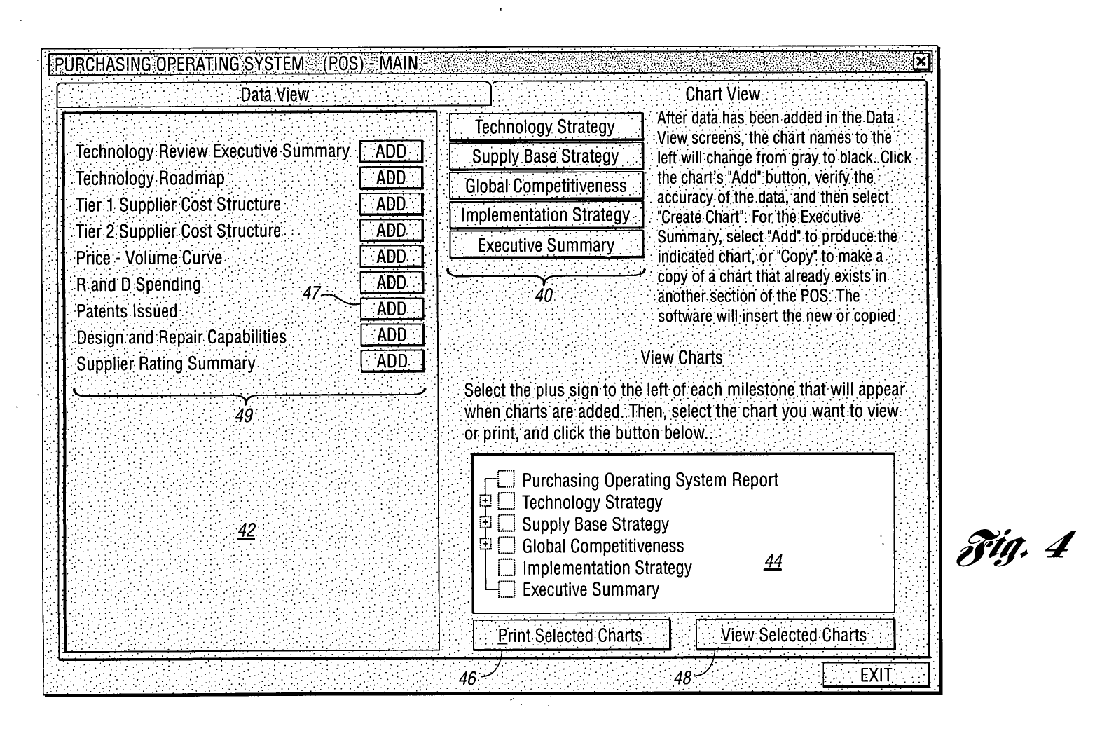

FIG. 4 is a GUI illustrating an example “Chart View” screen in accordance with one embodiment of the present invention. The Chart View screen includes a group of buttons 40 for toggling among different chart groups utilized for implementing the present invention (Technology Strategy, Supply Base Strategy, Global Competitiveness, etc.). Depending on the button selected, a listing of charts available for each button category is populated in region 42. Any charts that are selected in region 42 are automatically incorporated into a consolidated report summarizing the respective category or group of categories (Technology Strategy, Supply Base Strategy, Global Competitiveness, etc.). Region 44 interactively tracks the selected charts in a collapsible menu tree fashion. Buttons 46 and 48 allow a user to print or view selected charts from the consolidated report, respectively. Alternately, the user can view or print the consolidated report in its entirety.

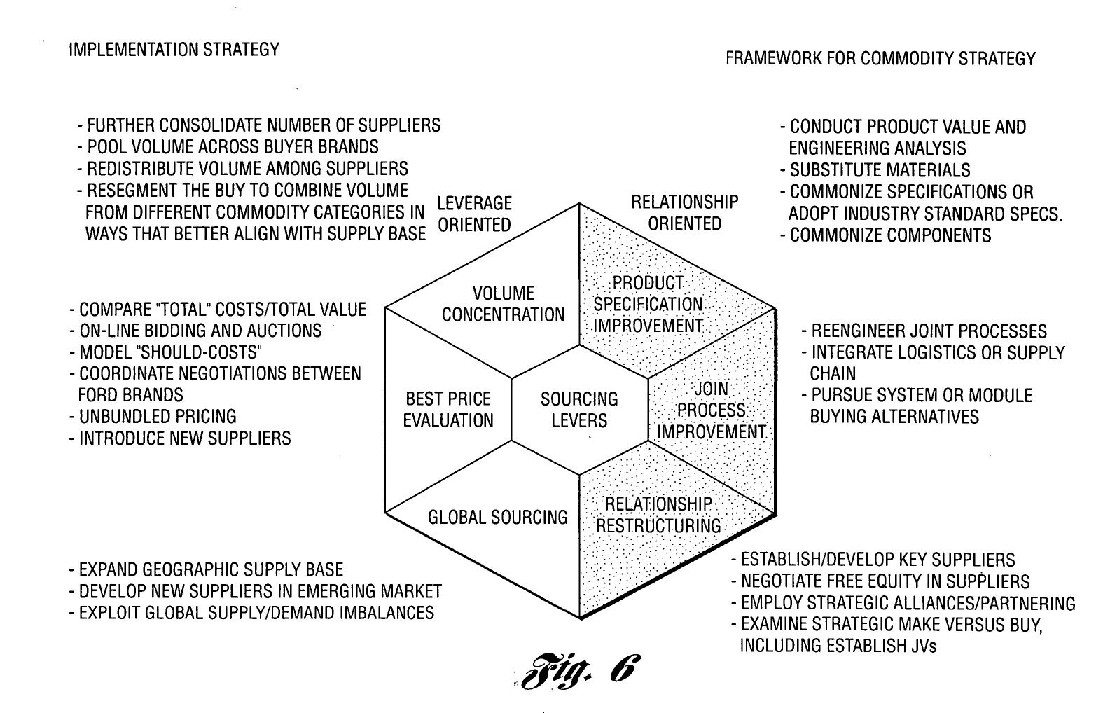

FIG. 4 is a GUI illustrating example chart options 49 for the “Technology Strategy” portion of the consolidated report. Upon selecting the “Add” button associated with a particular chart, the chart will automatically be generated within the consolidated report based on the data input via the “Data View” interfaces discussed and illustrated above. For example, the selection of the “Add” button 47 associated with “Patents Issued” will automatically generate the chart illustrated in FIG. 5 and automatically insert that chart into the consolidated report.

Table 2 below summarizes example “Technology Strategy” charts and other inserts available for automatic integration into the consolidated report in accordance with a preferred embodiment of the present invention.

TABLE 2

| Chart Type | Description |
|---|---|
| Technology | Summarizes what is known about the |
| Review | commodity technology |
| Executive | Established a baseline and legacy of |
| Summary | current knowledge strategies (updated |
| | regularly to account for evolving |
| | technology) |
| Technology | Graphically depicts a projected schedule |
| Roadmap | for introducing new technology into the |
| | buyer's program(s) |
| Tier 1 & 2 | Identifies the cost elements by |
| Supplier Cost | percentage within the supply base for the |
| Structure | purpose of comparison during negotiation. |
| | Major cost categories include materials |
| | (raw, purchased, packaging, etc.), labor |
| | (direct, indirect, MRO, etc.), overhead |
| | (corporate, manufacturing, r&d, warranty, |
| | transportation, etc.) and profit. |
| Price-Volume | Visual representation of the expected |
| Curve | cost reduction associated with an increase |
| | in volume or turnover. |
| | By increasing volume or turnover, the |
| | fixed cost from the supplier can be spread |
| | over a larger number of units, thereby |
| | reducing the cost per unit. |
| Research and | A qualitative comparison of annual |
| Development | research and development spending as a |
| Spending | percent of annual revenues. |
| Patents Issued | Assists in determining the relative |
| | technological capability of each supplier. |
| | This is an indicator of the supplier's |
| | commitment and capabilities in the area of |
| | technology. |
| Design and | An indication as to whether each |
| Repair | supplier out sources design and repair for |
| Capabilities | tooling and machinery. |
| | Provides insight into the suppliers' |
| | costs and flexibility. |
| Supplier | An overall supplier assessment in |
| Rating Summary | various categories (e.g., business |
| | relationship, performance, financial |
| | status, etc.) |

Similar to FIG. 4, a GUI illustrating chart options for the “Supply Base Strategy” portion of the consolidated report is provided (not shown). Upon selecting the “Add” button associated with a particular chart, the chart will automatically be generated within the consolidated report based on the data input via the “Data View” interfaces discussed and illustrated above. For example, the selection of the “Add” button associated with “Map of Annual Buy and Units” will automatically generate a chart illustrating the relative percentage of turnover and units by supplier over a period of time (based on input data). By selecting button 62, this chart is automatically inserted into the consolidated report.

Table 3 below summarizes example “Supply Base Strategy” charts and other inserts available for automatic integration into the consolidated report in accordance with a preferred embodiment of the present invention.

TABLE 3

| Chart Type | Description |
|---|---|
| Supply Base | Summarizes what is known about the |
| Strategy | commodity. |
| Executive | Established a baseline and legacy of |
| Summary | current knowledge strategies (updated |
| | regularly to account for evolving |
| | technology). |

Commodity Analysis

| | |
|---|---|
| Commodity | Graphically portrays “break points” in |
| Segmentation | the commodity that represents different |
| Tree | products, manufacturing processes, or |
| | supply bases. |
| | Displays business complexity in the |
| | commodity that may not be obvious when |
| | thinking about a single commodity code. |
| Map of Annual | Demonstrates the relationship of the |
| Buy and Units | supplier's total buyer turnover, the |
| | total number of parts shipped to the |
| | buyer and the associated average price. |
| Global Spend by | Displays supplier turnover mix by buyer |
| Supplier by | regions and brands, equaling the total |
| Brand/Region | buy. |
| NA Spend by | Graphical demonstration of North |
| Program | American Commodity Turnover by program. |
| Overall Map of | (by supplier/commodity): Provides a |
| Annual Buy | snapshot of turnover by commodity and by |
| | supplier for the commodity system. |
| | (by commodity/supplier): Displays the |
| | percentage of the total annual buy by |
| | component. |
| Forecast Spend | Shows how much the buyer spends |
| by Supplier | annually on the commodity and displays |
| | the suppliers with the highest dollars |
| | spent. |
| Forecast Spend | Deliverable shows how much the buyer |
| by Component | spends on the component annually and |
| | displays components with the highest |
| | dollars spent. |
| Supplier | This deliverable allows you to examine |
| Product Mix | the product mix for each supplier. |

Supplier Industry Analysis

| | |
|---|---|
| Competitive | Evaluation of the business environment |
| Environment | within the commodity's overall industry |
| Summary | (e.g., supplier power, threat of |
| | entrants, buyer power, threat of |
| | substitutes, internal rivalry, etc.). |
| | Identifies leverage and business |
| | opportunities/threats from the supplier |
| | perspective. |
| Supplier Rating | Each supplier is ranked from strongest |
| Summary | to weakest in a variety of categories: |
| | relationship (buyer turnover, long |
| | term supplier, strategic alignment); |
| | performance (quality, technology, |
| | cost, delivery, etc.); |
| | financial status. |
| Industry Market | Identifies market growth, segments, |
| Overview | segment growth, segment sales, etc. |
| | Four steps: |
| | 1. Determine total commodity |
| | purchases for next fiscal year by |
| | supplier; |
| | 2. Determine relevant segment size |
| | and growth; |
| | 3. Determine annual turnover by |
| | supplier; |
| | 4. Forecast annual buy from each |
| | supplier. |
| Industry Market | Illustrates annual buy relative to the |
| Map by Market | market, buyer share of supplier |
| by Supplier | production and segmentation of the annual |
| | buy. |
| | Helps select the appropriate |
| | segmentation for the industry. |
| | Identifies the dominant customer base. |
| Industry Market | Identifies what segments drive the |
| Map by Supplier | market (OEM, aftermarket, etc.). |
| by Customer | |
| Supplier Share | Identifies the supplier share for the |
| by Customer | buyer among other buyers. |
| | Shows which suppliers focus on which |
| | segment. |
| | Shows how the buyer's primary supplier |
| | is positioned in the market. |
| PPM Rate by | Reveals competitive quality levels |
| Supplier Site | sites (wide variances from quality |
| | objectives and best-in-class levels). |
| Supplier | Used to gauge supplier quality |
| Quality Data | performance (PPM, field actions, stop |
| | shipments, etc.). |
| | Used to address supply base performance |
| | in quality and value chain efficiency. |
| Value Chain | Identifies the level of integration of |
| Analysis | tier 1 suppliers. |
| | Defines the footprint of the supply |
| | chain. |
| | Graphically shows cross-tier suppliers, |
| | on-cost concentrations and waste |
| | reduction opportunities. |
| Total Market | Illustrates the total market segment |
| Overview - End | size and growth rate for the industry by |
| Use | consumer end-use for the commodity. |
| Industry Market | Indicates growth/demand of a commodity |
| Segment | in a certain vehicle system. |
| Overview | |
| Global Customer | Identifies relative customer support |
| Support | capability of each supplier. |
| Presence | Compares the number of supplier |
| | customer support locations by region. |
| Growth Rate | Illustrates the relative share of each |
| | supplier. |
| | Compares variations in market share |
| | over time by supplier. |
| | Helps identify dominant and struggling |
| | commodity suppliers. |

Similar to FIG. 4, a GUI illustrating chart options for the “Global Competitiveness” portion of the consolidated report may be provided in accordance with an embodiment of the present invention (not shown). Upon selecting the “Add” button associated with a particular chart, the chart will automatically be generated within the consolidated report based on the data input via the “Data View” interfaces discussed and illustrated above.

Table 4 below summarizes example “Global Competitiveness” charts and other inserts available for automatic integration into the consolidated report in accordance with a preferred embodiment of the present invention.

TABLE 4

| Chart Type | Description |
|---|---|
| Summary of | For in-depth understanding of |
| Opportunities and | supplier(s) the buyer has selected |
| Actions | Key deliverables: |
| | exercise cross-brand |
| | spending power; |
| | negotiate elements of 1^{st} |
| | tier value chain; |
| | expand supply base options; |
| | benchmark part design |
| | across brands. |

Cost Competitiveness Analysis

| | |
|---|---|
| Supplier Cost Element | Illustrates differentials in |
| Comparison | piece price and cost element |
| | structure (raw material, direct |
| | labor, indirect labor, overhead, R |
| | & D, etc.). |
| | Identifies BIC value chain cost |
| | model and opportunities for |
| | supplier improvement. |
| Labor Rate Data | Demonstrates relative wage rates |
| | for the suppliers' manufacturing |
| | locations. |
| | Includes the average labor rate |
| | by country. |
| | Demonstrates the supplier's |
| | geographic footprint. |
| Site-Focused Lean | Dock to Dock (DTD): the elapsed |
| Deployment Metrics | time between the unloading of raw |
| | materials and the release of |
| | finished goods for shipment. |
| | First Time Through (FTT): the |
| | percentage of units that complete |
| | a process and meet quality |
| | guidelines the first time without |
| | being scraped, rerun, retested, |
| | diverted for off-line repair, or |
| | returned. It is a measure of the |
| | quality of the manufacturing |
| | process. |
| | Overall Equipment Effectiveness |
| | (OCC): is a measure of the |
| | availability, performance |
| | efficiency, and quality rate of a |
| | given piece of equipment. |
| Part Price Comparison | Graphical price table for |
| | similar parts from the same and/or |
| | different suppliers. |
| | Identifies pricing |
| | inconsistencies between suppliers |
| | of similar parts. |
| Part Price v. Product | Correlates piece price with |
| Selling Price | vehicle selling price. |
| | Piece price may also be |
| | correlated with product weight, |
| | length area, etc. |
| Average Part Prices by | Identifies any suppliers priced |
| Supplier | above the industry average. |
| | Established lowest-price |
| | benchmark. |
| Supplier Average Part | Combines average part prices by |
| Prices and Volumes | supplier with supplier turnover to |
| | demonstrate impact of high/low |
| | prices on buyer's total buy for |
| | the commodity. |

Financial Metrics

| | |
|---|---|
| Action Score Rating | Score that represents the |
| | financial health of a supplier. |
| Liquidity | Indicates how easily the |
| | supplier's assets can be converted |
| | into cash. |
| Financial Efficiency | Indicates how well the |
| | supplier's assets are managed |
| | (inventory days, payable days, |
| | receivable days, sales/assets, |
| | etc.). |
| Leverage | Indicates how much debt the |
| | supplier requires to run its |
| | business. The higher the interest |
| | coverage, the higher the leverage |
| | (debt/equity, debt/asset, interest |
| | coverage, etc.). |
| Profitability | Indicates gross margin, |
| | operating margin, return on sales, |
| | etc., by supplier. |
| Relative Market Share | Numerically based comparison of |
| (RMS) | each supplier's relative market |
| | dominance. |
| | Calculated in relation to the |
| | next ranking market participant |
| | (RMS for the remaining market |
| | participants is then calculated in |
| | relation to the market leader). |

Experience Curve Analysis

| | |
|---|---|
| Price History Chart | Visual representation of the |
| | price of the commodity over time |
| | (e.g., 5-10 years). |
| | Demonstrates historical trends |
| | in industry pricing (by calendar |
| | year). |
| Experience Curve | Illustrates the rate of price |
| | decreases for a commodity over |
| | accumulated production. |
| | Demonstrates trends based on |
| | accumulated volume. |

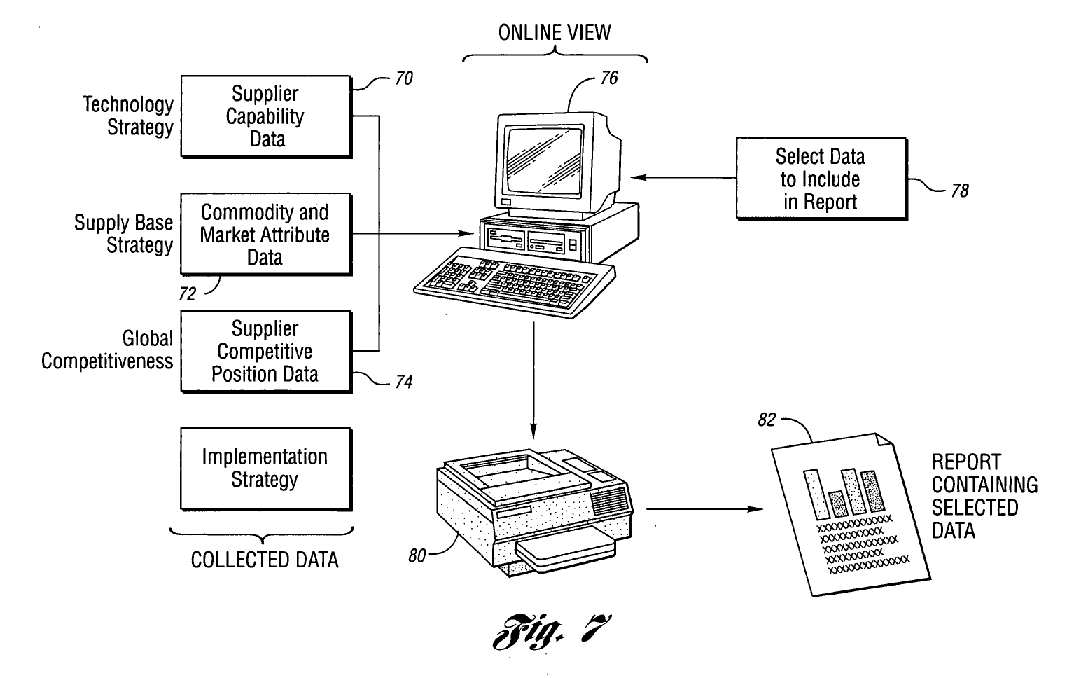

Notably, some of the data or charts that may be selected by a user for integration into the consolidated report may not be based, or wholly based, on the quantitative data input by the user via the “Data View” interfaces discussed and illustrated above. Some of the data or charts may be predefined forms, diagrams, instructions, etc. For example, selecting the “Add” button associated with the “Framework for Commodity Strategy” (Implementation Strategy category) will cause the predefined qualitative chart template illustrated in FIG. 6 to be automatically inserted into the consolidated report. The chart template is automatically populated with the relevant user-defined data (described in greater detail below).

FIG. 7 is a schematic diagram graphically illustrating a preferred system implementation of the present invention. Notably, the content or arrangement of a system implementation of the present invention may be modified or adapted to best fit a particular implementation scenario.

A preferred system implementation of the present invention includes at least one computer 76 (e.g., personal computer, laptop computer, thin/fat client in a client-server arrangement, etc.) operably programmed to receive input data such as categories 70, 72, 74 and process that data into a consolidated report 82. Data may be input to computer 76 in a wide variety of different fashions including but not limited to the example graphical user interfaces illustrated and described in greater detail above.

Report(s) 82 may be output in a variety of conventional manners including printing, presented for visual display, downloaded to a removable memory device or other computer device, etc. Additionally, as described and illustrated in greater detail above, computer 76 may be configured to receive input selecting or otherwise defining which portions of the input data to process into the consolidated report.

The “Implementation Strategy” aspect of the present invention may be implemented to identify competitive gaps and develop negotiation strategies between buyers and suppliers for a commodity. In a general sense, the implementation strategy aspect of the present invention represents an interpretation of analyses generated in accordance with the technology strategy, the supply base strategy, and the global competitiveness aspects of the present invention. The interpretation of this information assists the buyer in identifying a supplier's cost gap to benchmark as a percentage of their annual turnover, and may be utilized to develop a negotiation strategy paper. Outcomes of the implementation strategy of the present invention may include a 100-day study, a competitive gap analysis matrix, and negotiation strategy papers per supplier/commodity.

In one embodiment of the present invention, the implementation strategy can be divided into three phrases. A “Data Collection/Analysis Phase” aids the buying community in gathering supplier cost gap information from a variety of sources and tools, and helps organizes information in a form that is easily analyzed and conveyed to key stakeholders (including the supply base). Inputs to this phase include outputs from the technology strategy, supply base strategy, and global competitiveness aspects of the present invention illustrated and described in greater detail above.

The “Strategy Development Phase” may be implemented in a two-step process incorporating data and analyses collected and reviewed during the preceding phase, and distilling that data into a discrete implementation strategy for cost down efforts. This strategy may be reviewed with management prior to the deployment of the following phase.

The “Negotiation Phase” outlines a detailed plan for the buying community to work with internal stakeholders in the supply base during the time when cost down objectives may be implemented. The negotiation phase provides structure and process for buyer/supplier negotiations.

One action associated with phase one of the implementation strategy is scheduling purchasing activity for a purchasing cycle (e.g., a calendar year). This action allows individual buyers to keep a record of activities for the buying cycle that may have utility in achieving an optimal implementation strategy. These activities may include, but are not limited to, sourcing actions, online quoting events, and any other significant actions.

Another action associated with phase one of the implementation strategy is developing a performance forecast for negotiation. The performance forecast is a work plan format that may be used by a buyer to keep track of actions required to continue progress in negotiations. The work plan assists in keeping a negotiation team aware of status and future actions necessary to complete the implementation strategy. The work plan may be utilized to give assignments, measure progress, and understand the financial impact of each activity.

A progress plan deliverable for phase one of the implementation strategy is essentially a more detailed work plan format used to track key issues, actions planned, and lessons learned as the implementation strategy progresses. This document may be used to identify what the most significant influences are on the implementation strategy and which of those influences may result in immediate or long term commercial opportunities.

Another deliverable of the implementation strategy is a key supplier competitive gap analysis matrix. This document assists a buyer in understanding and documenting a supplier's competitive position and cost down opportunities within the marketplace. This document may be utilized during all three phases of the implementation strategy to provide buyer team members and suppliers with assessment data to better understand competitive positions, plan for necessary cost downs in annual budgets, and generally work towards achieving a more competitive position within the commodity base. The matrix may be based on a premise that a supplier's competitive position can be viewed in at least two areas. One area is the price gap between the supplier and its competition. Another area is a cost and market gap due to process inefficiencies and the impact of global to local market conditions on the supplier. Cost gaps may be determined with tools such as Kaizen, value stream mapping, volume and experience curves, financial statement analyses, etc. The cost gap measures the “opportunity” for a supplier to use continuous improvement techniques internally to drive costs out of their system.

Preferably, a competitive gap analysis matrix is completed on a supplier-by-supplier basis within or across commodities/brands. It is additionally preferred that the matrix is updated on a regular basis to allow a buyer to capture the total competitive position of the suppler via cost and market analysis tools utilized throughout the year. Information for populating the competitive gap analysis matrix typically may be found in three general areas. One area includes competitive cost exercise results such as market tests, design competitions, and quoting events. Another area includes total cost management exercises such as value stream mapping and Kaizen efforts. A third category includes general market data, such as financial statement analysis, experience curve analysis, supplier road map reviews, cost estimates, etc. These categories of data allow a buyer to develop a robust strategy and engage in a data-drive discussion to foster a cost down agreement with its suppliers.

Another aspect of phase one of the implementation strategy is a regional cost objectives review. This aspect may assist a buyer in understanding objectives and expectations for the buyer's region. A 100-day study may be implemented to conduct regional cost objectives, identifying teams, tools, and initiatives that meet annual cost reduction efforts. Buyer level involvement in the 100-day study helps to formulate a strategy for individual department/section/commodity in supplier-level negotiations.

Another aspect of phase one of the implementation strategy is a cross-brand/cross-community turnover analysis. This aspect may be implemented to ensure that all turnover, leverage, and cost down opportunities are available for review and negotiation. Another objective of this aspect is to identify turnover for a given key supplier. This aspect of the present invention is valuable for analyzing smaller suppliers that often have turnover across several buyer regions and commodities. Productivity improvements on total turnover for smaller suppliers can have a substantial impact on a buyer's profits.

Another aspect of phase one of the implementation strategy is the supplier cost down roadmap. Preferably, this document is provided by a supplier and includes information such as cost saving opportunities, quantitative estimates of potential savings, design and non-design cost saving opportunities, a confidence level estimate (e.g., percentage, high/medium/low, etc.), an estimated annual dollars impact effect, a lead contact person, and an estimated time of successful implementation.

One deliverable associated with the strategy development phase of the implementation strategy is a framework for the commodity strategy. In one embodiment, the framework is a chart demonstrating business dynamics within the commodities industry, and may include industry dynamics from the supplier's perspective. In a general sense, the framework may be utilized to determine whether the buyer's association with its suppliers within the supply base is leverage-orientated or relationship-oriented. Once this association is established, opportunities to advance the buyer's position within this supplier market in specific actions to advance the opportunities outside of the facets may be identified. FIG. 6 illustrates an example framework for a commodity strategy.

Another deliverable associated with the strategy development phase of the implementation strategy is the commodity strategy document. This document may be used to review, refine, and obtain management buy-in to the overall implementation strategy prior to negotiations with suppliers. The commodity strategy is a detailed plan for annual negotiations that may compliment the overall commodity strategy. Notably, this strategy can be developed at the commodity level or at the supplier level. In addition, the format is commodity-specific, meaning that there is no required format for the commodity strategy document. Aspects of the commodity strategy document may include a summary of the previous/current year turnover by supplier, a turnover pricing trend, pricing gaps for each supplier between the price currently paid for the commodity and the cost-down price that their manufacturer/buyer intends to drive the supplier to based on information and resources described in accordance with the present invention (above), a “roadmap” summarizing the manner in which the buyer/supplier will achieve the cost-down price (e.g., a value chain analysis, an on-line quote for parts that make up the commodity, benchmarking the commodity against competing suppliers, etc.), a summary of buyer turnover for the commodity by buyer brand, a summary of who the suppliers currently are for the different buyer brands, a value chain cost structure for the commodity (e.g., raw material, parts, overhead, labor, etc.), and a scheduling summary for implementing the cost-down roadmap.

One action that may be associated with the negotiation phase of the implementation strategy is supplier negotiation kickoff meetings. The purpose of this meeting is to convey an array of expectations and concerns of key suppliers regarding cost down efforts. Preferably, meetings are held with suppliers individually. During this aspect of the present invention, the negotiation strategy will be employed.

Discussion topics at the kickoff meetings may include, but are not limited to, a supplier-specific report card review, brand or commodity-specific expectations for cost down for each supplier, definitions of key metrics (e.g., turnover, productivity, non-design credits, target agreements, timing, percent versus $ commitments, etc.), expectations of individual suppliers based on the competitive gap analysis, potential new sourcing opportunities, timing expectations for the supplier to respond to closeout cost down commitments, potential impacts of negative or delayed settlements on business relationships, discussion around varying approaches to achieve breakthrough productivity (e.g., texturing, VA/VE sharing, etc.), a “Next Steps” discussion with the supplier to ensure the process moves forward.

Another action associated with the negotiation phase of the implementation strategy may include competitive gap review meetings. These meetings are implemented to review the rationale for cost-down expectations with suppliers, preferably in a formal setting. The meeting may provide a fact-based discussion forum (speak with data), as well as a brand-by-brand review that reinforces expectations. During a gap review meeting, it may be conveyed to a supplier that a review of the data highlighting cost gaps has been conducted with supplier representatives.

Another deliverable that may be associated with the negotiation phase of the implementation strategy is a supplier negotiation strategy paper. This may be implemented as a one-page document completed by the buyer for each supplier that will be engaged in significant cost down negotiations. This paper provides a buyer with a one-page summary that lists key supplier data such as estimated yearly supplier turnover, supplier's business with the buyer's brands, buyer leverage points, potential negotiation points, minimal acceptance values, estimated cost gap, recent year productivity commitments, supplier leverage points, and potential sourcing opportunities. The negotiation strategy paper may be used during negotiations and meetings with suppliers to better respond to supplier concerns based on fact. Preferably, the paper is used in conjunction with a practice negotiation meeting to help a buyer anticipate issues and improve control of individual negotiation meetings with suppliers.

Another deliverable that may be associated with the negotiation phase of the implementation strategy is a supplier settlement status matrix. The supplier settlement status matrix may help ensure that individual buyers and their management are aware of the status, next steps, and impact of current supplier negotiations on buyer strategies. Preferably, a matrix is created for each supplier. Some suppliers may be large corporations that supply the buyer, at a minimum, with one commodity of a significant volume, or across several commodities and departments. This matrix will assist buyers in understanding both opportunities and the impact of negotiations with suppliers that cross several commodities and/or buyer brands. Even if a supplier is unique to a particular section/commodity within a brand, the matrix may provide a “working document” to track and monitor progress of negotiations. The supplier settlement status matrix assembles important data sets including, but not limited to, supplier turnover, competitive gap, negotiation status, next steps, etc. Different techniques may be used to analyze a supplier's cross-brand/cross-commodity impact. If the commodity is part of a supplier's global commodity, then turnover globally and by brand, brand specific expectations, and potential sourcing implications may be conveyed and understood among buyer team members. If a commodity's key suppliers are regional, only a review of turnover across departments within the region may be necessary to track and communicate. Notably, if a supplier negotiation goes beyond one offer, the matrix can be expanded by simply adding columns to continue tracking multiple offer progress over time.

Another deliverable that may be associated with the negotiation phase of the implementation strategy is a commodity management review plan. This may be implemented as a one-page progress report used to convey the negotiation phase status to buyer management. The plan may allow management to anticipate timing for negotiation acceleration (where required), to prompt the buyer/manager to prepare for higher-level meetings with a supplier, and monitors the progress of the buying community towards meeting implementation strategy objectives.

Another deliverable that may be associated with the negotiation phase of the implementation strategy is a negotiation settlement file. Preferably, this is a hard copy file including key documentation relating to any yearly cost-down agreement that was reached between the buyer and supplier during negotiations. Preferably, the buyer is responsible for maintaining this document.

While the best mode for carrying out the invention has been described in detail, those familiar with the art to which this invention relates will recognize various alternative designs and embodiments for practicing the invention as defined by the following claims.

1. A method for generating a report for use in buyer/supplier negotiations for purchasing a commodity, the method comprising:
collecting data to define the technical capabilities of two or more suppliers to supply a commodity to a buyer;
collecting data to define attributes of the commodity and the commodity market;
collecting data to define the relative competitive position of two or more suppliers; and
inputting the collected data into a computer operably configured to process at least a portion of the collected data and output a report for use in buyer/supplier negotiations for purchasing the commodity wherein the report includes at least a portion of the collected data.

2. The method of claim 1 additionally comprising negotiating a supply agreement with at least one of the selected suppliers based on information provided in the strategy report.

3. The method of claim 2 additionally comprising identifying one or more competitive opportunities based on the report and requiring that the supplier (i) adopt one or more competitive opportunities identified in the report, or (ii) agree to adjusted contract terms in compensation for not adopting one or more of the competitive opportunities identified in the strategy report.

4. The method of claim 3 wherein the competitive opportunities include cost reduction, quality improvement or capability improvement.

5. The method of claim 3 additionally comprising communicating at least a portion of the report to the supplier during the negotiation.

6. The method of claim 1 additionally comprising the step of selecting a subset of the data defining (i) the technical capabilities of the selected suppliers, (ii) the attributes of the commodity and the commodity market, or (iii) the relative competitive position to include in the report.

7. A system for generating a report for use in buyer/supplier negotiations for a commodity, the system comprising at least one computer operably programmed to:
receive input data defining technical capabilities of two or more suppliers of a commodity;
receive input data defining attributes of the commodity and the commodity market;
receive input data defining a relative competitive position of two or more of the suppliers;
process the input data to generate a report including at least a portion of the input data; and
output the strategy report.

8. The system of claim 7 wherein the computer is additionally configured to receive input selecting a subset of the input data to be included within the report.

9. A method for negotiating a supply agreement for a commodity, the method comprising:
a step for implementing a technology strategy;
a step for implementing a supply base strategy; and
a step for implementing a global competitiveness strategy.

10. The method of claim 9 additionally comprising a step for negotiating a supply agreement with one or more suppliers based on the technology strategy, the supply base strategy and the global competitiveness strategy.
